(19) United States
(12) Patent Application Publication
(10) Pub. No.: US 2013/0153050 A1
(43) Pub. Date: Jun. 20, 2013

(54) HIGH RECIRCULATION FUEL VAPOR REDUCTION SYSTEM

(71) Applicant: CHRYSLER GROUP LLC, Auburn Hills, MI (US)

(72) Inventors: Michael R. Teets, Grosse Pointe Park, MI (US); Trevor L. Enge, West Bloomfield, MI (US)

(73) Assignee: CHRYSLER GROUP LLC, Auburn Hills, MI (US)

(21) Appl. No.: 13/709,845

(22) Filed: Dec. 10, 2012

Related U.S. Application Data
(60) Provisional application No. 61/577,158, filed on Dec. 19, 2011.

(51) Int. Cl. B60K 15/04

(52) U.S. Cl. CPC B60K 15/04
USPC 137/154

(57) ABSTRACT

An apparatus for recirculating fuel vapors in a vehicle. The apparatus includes a filler head connected to a fuel vapor conduit and a tubular aspirator located within the filler head. The aspirator has at least one orifice in its side wall so that when fuel flows through the aspirator when the vehicle is refueled, a low pressure area that draws fuel vapors through the orifice and into the fuel flow within the aspirator is created.

### CROSS-REFERENCE TO RELATED APPLICATION

This application claims the benefit of U.S. Provisional Ser. No. 61/577,158, filed Dec. 19, 2011.

### FIELD

The present disclosure relates to an apparatus for vehicle fuel systems and, more particularly to, an apparatus that recirculates fuel vapors within the fuel system.

### BACKGROUND

Vehicle fuel systems are required to prevent fuel vapors created in the vehicle's fuel tank from releasing into the atmosphere when the vehicle is refueled. To reduce the fuel vapors in the tank, and thereby reduce the amount of fuel vapors that are released into the atmosphere, some vehicles contains carbon canisters that collect and store the fuel vapors until the vapors can be drawn into the engine and burned off during combustion. The carbon canisters need to be sized appropriately to be able to store the necessary amount of fuel vapors. Carbon canister sizing in hybrid vehicles presents a particular problem because, under some driving conditions, there will be no combustion that can burn off the vapors from the carbon canister. As a result, hybrid vehicles may have large carbon canisters. Because space is a premium in most vehicle types, reduction in the size of the carbon canister is desired. Furthermore, the reduction in the size of the carbon canister reduces costs, which is also desired.

To reduce the size of the canisters, some vehicles recirculate the fuel vapors so that they mix with the incoming fuel and enter the fuel tank. However, these recirculation systems typically have large variances in the amount of fuel vapor that is recirculated. As a result, the size of the canister may only be minimally reduced. Furthermore, many of the recirculation systems may cause spit-back or fuel spray and release fuel vapors into the atmosphere during the refueling process. Thus, there is a need for a recirculation system that increases fuel vapor recirculation, reduces the variation of the amount of fuel vapor recirculated, and reduces spit-back, fuel-spray, and the release of fuel vapors during the refueling process.

### SUMMARY

The present disclosure provides an apparatus for recirculating fuel vapors. The apparatus includes a fuel vapor conduit, a filler head connected to the fuel vapor conduit, and a hallow tubular aspirator open at both ends and located within the filler head. The aspirator has at least one orifice in its side wall so that a fuel flow through the aspirator draws the fuel vapors through the at least one orifice and into the fuel flow within the aspirator.

In one embodiment, the aspirator may be movably located within the filler head and may be connected to the filler head by a guide rod. The guide rod may have a corresponding guide spring that applies a force to the aspirator. The aspirator may have a lip at one end that is connected to the guide rod and the corresponding guide spring. In another embodiment, the aspirator may be connected to the filler head by three guide rods and the aspirator may have more than four orifices.

In use, the aspirator may mate with a nozzle that dispenses fuel and may have an inner diameter that is larger than an inner diameter of the nozzle. Furthermore, the fuel flow from the nozzle into the aspirator may create a low pressure area in the aspirator that draws the fuel vapors through the orifice and into the fuel flow within the aspirator.

The apparatus may further include an aspirator guide within the filler head with an opening aligned with the aspirator. In use, the nozzle may pass through the aspirator guide before mating with the aspirator.

In another embodiment, the present disclosure provides an apparatus for recirculating fuel vapors from a fuel tank. The apparatus includes a fuel conduit connected to the fuel tank, a fuel vapor conduit connected to the fuel tank, and a filler head having a first end and a second end, the filler head being connected to the fuel conduit and the fuel vapor conduit. The filler head is designed to accept a nozzle that dispenses fuel at the first end. The apparatus further includes a hallow tubular aspirator open at both ends and located within the filler head. The aspirator has a first end proximate the first end of the filler head and one orifice passing completely through a side wall of the aspirator near the aspirator first end to connect an internal portion of the aspirator to an internal portion of the filler head.

In one embodiment, the aspirator may be movably connected to the filler head. In another embodiment, the aspirator may be connected to the filler head by at least one guide rod with a corresponding guide spring. In use, the aspirator may contact a nozzle that dispenses fuel. Furthermore, in use, the aspirator may move between the first and second ends of the filler head to maintain contact with the nozzle.

In another embodiment, fuel dispensed into the first end of the filler head may pass through the aspirator. The fuel passing through the aspirator may create a low pressure area near the first end of the aspirator that may draw the fuel vapors from the fuel tank through the at least one orifice and into the fuel passing through the aspirator.

Further areas of applicability of the present disclosure will become apparent from the detailed description, drawings, and claims provided hereinafter. It should be understood that the detailed description, including disclosed embodiments and drawings, are merely exemplary in nature, intended for purposes of illustration only, and are not intended to limit the scope of the invention, its application, or use. Thus, variations that do not depart from the gist of the invention are intended to be within the scope of the invention.

### BRIEF DESCRIPTION OF THE DRAWINGS

FIG. 1 illustrates a diagram of a fuel system according to an exemplary embodiment.

FIG. 2 illustrates a portion of the fuel system of FIG. 1 according to an exemplary embodiment.

FIG. 3a illustrates a cross-section of a filler head according to an exemplary embodiment.

FIG. 3b illustrates another cross-section of a filler head according to an exemplary embodiment.

FIG. 4 illustrates another cross-section of a filler head according to an exemplary embodiment.

### DETAILED DESCRIPTION

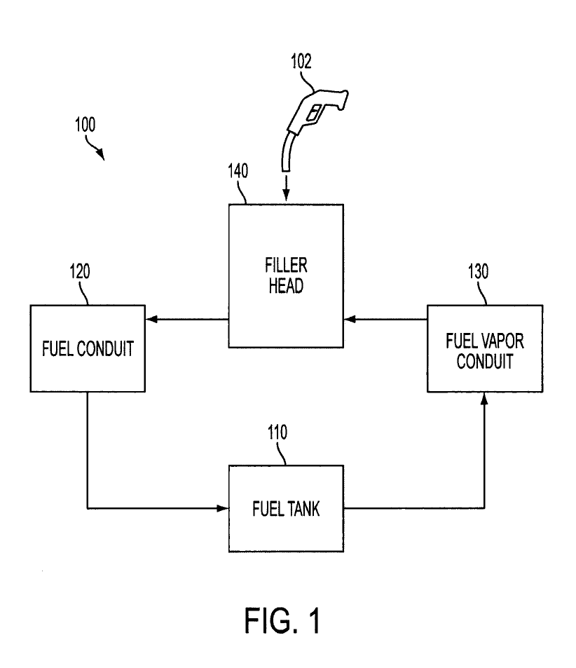

FIG. 1 illustrates a diagram of a vehicle's fuel system 100 according to an exemplary embodiment. The fuel system 100 includes a fuel tank 110, fuel conduit 120, fuel vapor conduit 130, and filler head 140. The fuel tank 110 stores fuel for the vehicle and is connected to filler head 140 by way of the fuel conduit 120 and the fuel vapor conduit 130. The filler head 140 provides access to the fuel system 100 and interacts with a fuel pump nozzle 102. In use, the filler head 140 mates with the fuel pump nozzle 102 and fuel flows from the nozzle 102 into the filler head 140 through the fuel conduit 120 and into the fuel tank 110. Fuel vapors from the fuel tank 110 pass through the fuel vapor conduit 130 into the filler head 140 and are introduced into and become a part of the incoming liquid fuel flow and are sent back into the fuel tank 110 as liquid fuel. In this manner, the fuel system 100 recirculates fuel vapor from the fuel tank 110.

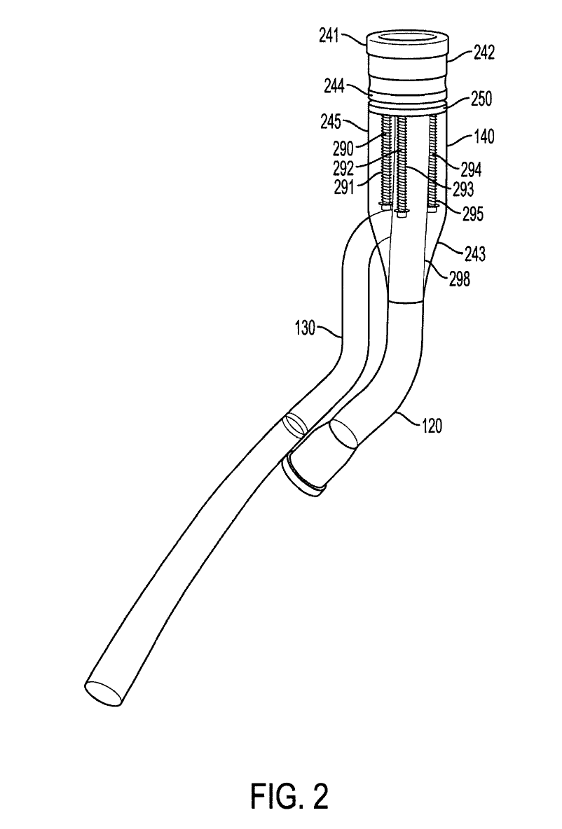

FIG. 2 illustrates details of the filler head 140 according to an exemplary embodiment. The filler head 140 includes a fuel cap retainer 242; an aspirator guide 244; aspirator 250; guide rods 290, 292, 294; guide springs 291, 293, 295; and a fuel tube 298. The filler head 140 has a hallow cylindrical body 245, fuel introduction end 241, and fuel exit end 243. The fuel introduction end 241 accepts the fuel pump nozzle 102. The fuel exit end 243 has a frusto-conical shape and connects to the fuel conduit 120. The fuel vapor conduit 130 connects to the body 245.

The fuel cap retainer 242 sits a top the fuel introduction end 241 of the filler head 140 and extends partially into the body 245. The aspirator 250 resides within the body 245 of the filler head 140 and is movably connected to the filler head 140 by way of the guide rods 290, 292, 294 and corresponding guide springs 291, 293, 295. The fuel tube 298 is connected to the aspirator 250 and extends through the body 245 and into the fuel exit end 243 of the filler head 140. The aspirator guide 244 resides within the filler head 140 between the aspirator 250 and the fuel cap retainer 242. In use, the nozzle 102 extends through the fuel cap retainer 242 and aspirator guide 244 and mates with the aspirator 250. Fuel dispensed from the nozzle 102 flows through the aspirator 250 into the fuel tube 298 and then into the fuel conduit 120. In another embodiment, the filler head 140 may include a doughnut shaped nozzle seal that rests on the aspirator guide 244 within the fuel cap retainer 242. The nozzle seal may help to increase the efficiency of the fuel system 100 as it recirculates fuel vapor from the fuel tank 110.

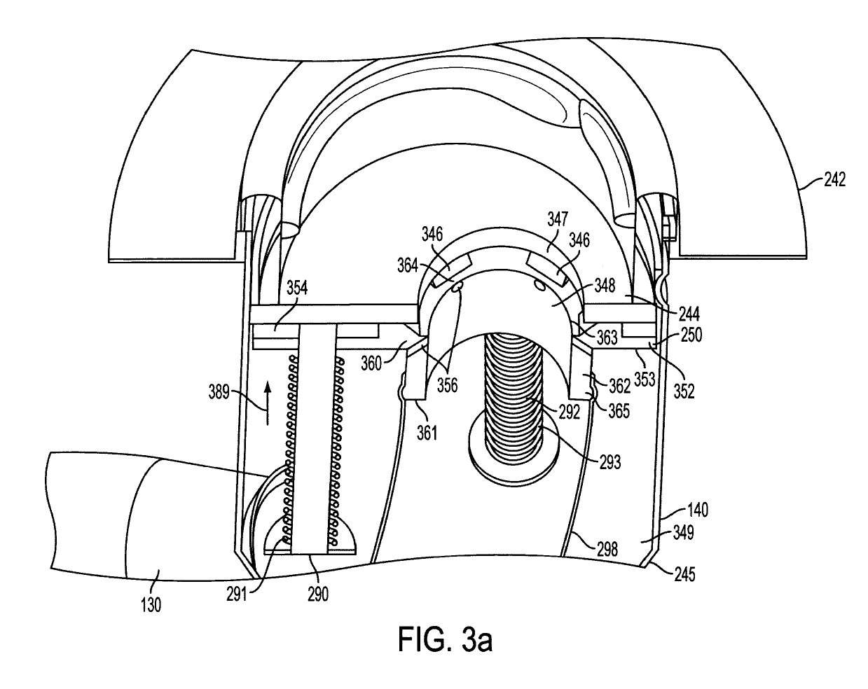

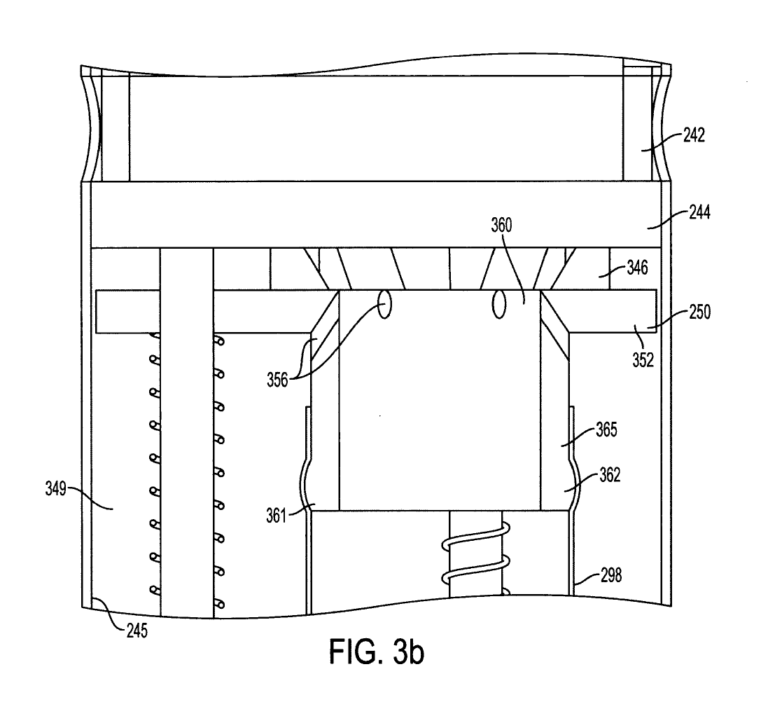

FIGS. 3a and 3b illustrate cross-sections of the filler head 140 according to an exemplary embodiment. As illustrated in FIG. 3a, the fuel cap retainer 242 is attached to a top portion of the body 245 of the filler head 110. The aspirator guide 244 mates with the fuel cap retainer 242 and creates a seal along the body 245. The aspirator guide 244 has an opening 348 that extends through the aspirator guide 244. A central axis of the opening 348 is offset from the central axis of the filler head 140. In another embodiment, the central axis of the opening 348 may be aligned with the central axis of the filler head 140.

The aspirator 250 includes a hallow shaft 362 with a lip 352 at a first end 360 of the shaft 362 near the aspirator guide 244 that extends away from the shaft 362 out to the body 245 of the filler head 140. A central axis of the hallow shaft 362 aligns with the central axis of the opening 348. The lip 352 is offset from the aspirator guide 244 by guide pieces 346 that contact a top surface 354 of the lip 352. The guide pieces 346 slope from an outer portion 347 of the opening 348 toward the shaft 362 but do not extend to the edge 363 of the shaft 362, thereby creating a ledge 364 between the edge 363 and the guide pieces 346.

The guide rod 290 connects to the aspirator guide 244 and the body 245 and extends through an opening in the lip 352 of the aspirator 250. The guide spring 291 extends between the bottom of the guide rod 290 and a bottom surface 353 of the lip 352 and applies a force to the aspirator 250 in the direction of arrow 389. Guide rods 292, 294 (FIG. 2) and guide springs 293, 295 (FIG. 2) connect to the aspirator guide 244, body 245, and aspirator 250 in a similar manner. The guide rods 290, 292, 294 are evenly spaced around the inner periphery of the filler head 140 and operate to allow aspirator 250 to move along the guide rods 290, 292, 294 within the filler head 140. When no outside force is applied to the aspirator 250, the guide springs 291, 293, 295 position the aspirator 250 next to the aspirator guide 244.

In another embodiment, four guide rods 290 may be used to movably connect the aspirator 250 within the filler head 140 and may be unevenly spaced around the periphery of the filler head 140. In yet another embodiment, two guide rods 290 may be used to movably connect the aspirator 250 within the filler head 140 and may be evenly spaced around the periphery of the filler head 140. In yet another embodiment, hydraulics may be used to movably connect the aspirator 250 within the filler head 140. It should be understood that any means of movably connecting the aspirator 250 to and within the filler head 140 may be implemented without departing from the scope of the invention.

As illustrated in FIG. 3b, the shaft 362 of the aspirator 250 extends away from the lip 352 and the aspirator guide 244. The second end 361 of the shaft 362 is connected to the fuel tube 298. The first end 360 of the shaft 362 has six orifices 356 with inner openings in the inner portion of the shaft 362 just below the edge 363. The orifices 356 extend through the wall 365 of the shaft 362 at an angle and have outer openings on the outer portion of the shaft 362 below the lip 352 of the aspirator 250. The orifices 356 connect the internal space 349 of the filler head 140 with the inside portion of the shaft 362. The orifices 356 are cylindrical, have a diameter between about 1 and about 5 mm, and are evenly spaced around the periphery of the shaft 362. In another embodiment, the orifices 356 may be rectangular, oval, hexagonal, or any other shape and may be unevenly spaced around the periphery of the shaft 362. In yet another embodiment, the aspirator 250 may have more or less than six orifices 356, and each orifice 356 may have a varying shape and diameter.

Referring to FIGS. 1-3b, in use, the fuel pump nozzle 102 extends through the guide opening 348 and contacts the ledge 364 of the aspirator 250. If the nozzle 102 is not in contact with the ledge 364 during the fueling process (when the nozzle 102 is dispensing fuel into the filler head 140) spit-back, fuel spray, and the release of fuel vapors into the atmosphere may occur. To avoid these negatives events, the guide rods 290, 292, 294 and corresponding guide springs 291, 293, 295 operate to ensure that fuel pump nozzles 102 of varying lengths contact the ledge 364 of the aspirator 250 when inserted into the filler head 140. The guide rods 290, 292, 294 and corresponding guide springs 291, 293, 295 also operate to ensure that the fuel pump nozzle 102 inserted at varying depths within the filler head 140 contacts the ledge 364 of the aspirator 250.

For example, in one embodiment, a four inch long nozzle 102 inserted into the filler head 140 contacts the ledge 364 of the aspirator 250 and moves the aspirator 250 one-half of an inch along the guide rods 290, 292, 294 toward the fuel exit end 243 of the filler head 140. In the same embodiment, a five inch long nozzle 102 inserted into the filler head 140 contacts the ledge 364 of the aspirator 250 and moves the aspirator 250 one and one-half inches along the guide rods 290, 292, 294 toward the fuel exit end 243 of the filler head 140. If the aspirator 250 was not movably connected to the filler head 140, the nozzle 102 would not have been in contact with the ledge 364 of the aspirator 250 in one or both of these instances. As a result, fuel spray, spit-back, and release of fuel vapors into the atmosphere would occur during the fueling process. Because the aspirator 250 is movably connected within the filler head 140, however, nozzles 102 of varying length will contact the aspirator 250 when inserted into the filler head 140 and fuel spray, spit-back, and fuel vapor release is avoided during the fueling process.

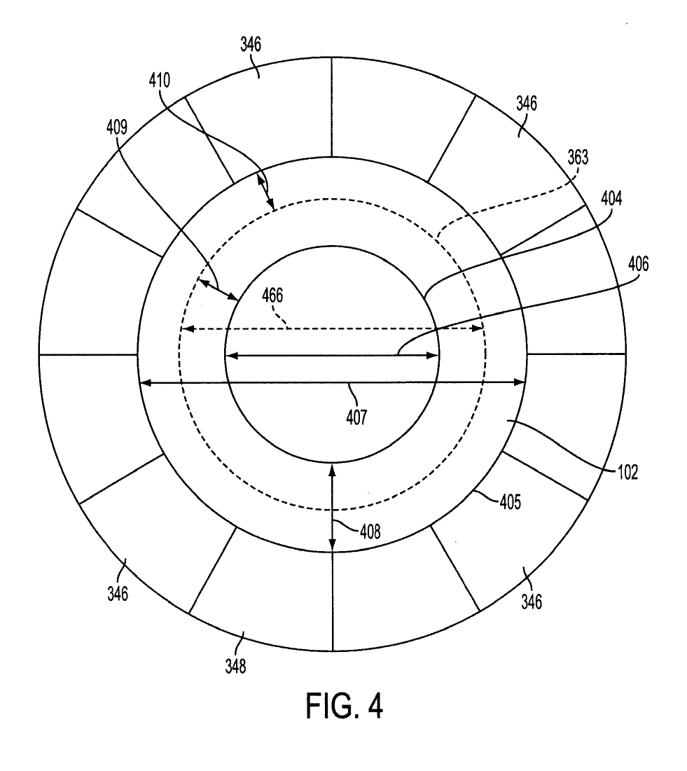

FIG. 4 illustrates a cross-sectional top view of the nozzle 102 mating with the aspirator 250 in accordance with an exemplary embodiment. The nozzle 102 is circular shaft that has an inner surface 404, outer surface 405, and thickness 408 between the inner and outer surfaces 404, 405. The nozzle 102 has an inner diameter 406 smaller than an inner diameter 466 of the shaft 362 and an outer diameter 407 larger than the inner diameter 466 of the shaft 362. As a result, an outer portion 410 of the end of the nozzle 102 contacts the ledge 364 of the aspirator 250 and an inner portion 409 extends past the edge 363 and partially covers the shaft 362. The guide opening 348 and the guide pieces 346 position the nozzle 102 so that it mates with the ledge 364 as illustrate in FIG. 4.

It is understood that nozzles that dispense fuel are designed so that the thickness and diameter of the nozzles have the same specifications with minimal variance. As a result, the aspirator 250 mates with most nozzles in the manner described above. It is further understood that nozzles for different types of fuel may have different specifications. For example, diesel fuel nozzles may have a different diameter than gasoline nozzles. The aspirator 250 may be sized for different vehicle types to account for any difference in nozzle diameter or thickness. It is further understood that the length of a nozzle is not controlled and varies from nozzle to nozzle.

In use, the nozzle 102 dispenses fuel into the shaft 362. As the fuel flows from the smaller diameter nozzle 102 to the larger diameter shaft 362, a vacuum or low-pressure area is created at the junction of the nozzle 102 and the shaft 362 due to the Venturi effect. Specifically, the low-pressure area is created in the shaft 362 near the shaft's 362 edge 363 below the inner portion 409 of the nozzle 102 and near the inner openings of the orifices 356. The low-pressure area inside the shaft 362 causes air to flow from the internal space 349 within the filler head 140 into the shaft 362 of the aspirator 250 through the orifices 356. Because the fuel vapor conduit 130 is connected to the internal space 349 within the filler head 140, the low pressure area inside the shaft 362 draws fuel vapor from the fuel tank 110 through the fuel vapor conduit 130 into the internal space 349 within the filler head 140 and through the orifices 356 into the shaft 362. Once within the shaft 362, the fuel vapors interact with the fuel flowing from the nozzle 102, recondense, and are introduced back into the fuel tank 110.

Besides reducing spit-back, fuel spray, and fuel vapor release, the guide rods 290, 292, 294 and corresponding guide springs 291, 293, 295 also operate to ensure that the fuel pump nozzle 102 contacts the ledge 364 of the aspirator 250 when nozzles 102 of varying lengths are inserted into the filler head 140 so that a constant low pressure area is maintained within the aspirator 250. Maintaining a constant low pressure area reduces the variation in the amount of fuel vapor recirculation. Furthermore, large amounts of fuel vapor may be recirculated using the fuel system 100 because the fuel vapor is continually drawn into the fuel flow by the low pressure area created within the aspirator 250. As a result, the size of a vehicle's carbon canister may be reduced.

What is claimed is:

1. An apparatus for recirculating fuel vapors, the apparatus comprising:
a fuel vapor conduit;
a filler head connected to the fuel vapor conduit; and
a hallow tubular aspirator open at both ends and being located within the filler head, the aspirator having at least one orifice in a side wall thereof, wherein in use, a fuel flow through the aspirator draws the fuel vapors through the at least one orifice and into the fuel flow within the aspirator.

2. The apparatus of claim 1, wherein the aspirator is movably located within the filler head.

3. The apparatus of claim 2, wherein the aspirator is movably connected to the filler head by at least one guide rod.

4. The apparatus of claim 3, wherein the at least one guide rod has a corresponding guide spring that applies a force to the aspirator.

5. The apparatus of claim 3, wherein the aspirator is connected to the filler head by three guide rods.

6. The apparatus of claim 4, wherein the aspirator has a lip at one end that is connected to the at least one guide rod and the corresponding guide spring.

7. The apparatus of claim 1, wherein aspirator has more than four orifices.

8. The apparatus of claim 1, wherein, in use, the aspirator mates with a nozzle that dispenses the fuel.

9. The apparatus of claim 8, wherein an inner diameter of the aspirator is larger than an inner diameter of the nozzle.

10. The apparatus of claim 9, wherein the fuel flow from the nozzle into the aspirator creates a low pressure area in the aspirator that draws the fuel vapors through the at least one orifice into the fuel flow within the aspirator.

11. The apparatus of claim 8, further comprising an aspirator guide within the filler head, the guide having an opening aligned with the aspirator.

12. The apparatus of claim 11, wherein, in use, the nozzle pass through the aspirator guide before mating with the aspirator.

13. An apparatus for recirculating fuel vapors from a fuel tank, the apparatus comprising:
a fuel conduit connected to the fuel tank;
a fuel vapor conduit connected to the fuel tank;
a filler head having a first end and a second end and connected to the fuel conduit and the fuel vapor conduit, the filler head adapted to accept a nozzle that dispenses fuel at the first end; and
a hallow tubular aspirator open at both ends within the filler head, the aspirator having a first end proximate the first end of the filler head and at least one orifice passing completely through a side wall of the aspirator near the aspirator first end to connect an internal portion of the aspirator to an internal portion of the filler head.

14. The apparatus of claim 13, wherein the aspirator is movably connected to the filler head.

15. The apparatus of claim 14, wherein the aspirator is connected to the filler head by at least one guide rod with a corresponding guide spring.

16. The apparatus of claim 14, wherein, in use, the aspirator contacts a nozzle that dispenses fuel.

17. The apparatus of claim 16, wherein, the aspirator moves between the first and second ends of the filler head to maintain contact with the nozzle.

18. The apparatus of claim 13, wherein, in use, the fuel dispensed into the first end of the filler head passes through the aspirator.

19. The apparatus of claim 18, wherein the fuel passing through the aspirator creates a low pressure area near the first end of the aspirator.

20. The apparatus of claim 19, wherein the low pressure area draws the fuel vapors from the fuel tank through the at least one orifice into the fuel passing through the aspirator.
